(19) United States
(12) Patent Application Publication
(10) Pub. No.: US 2019/0390776 A1
(43) Pub. Date: Dec. 26, 2019

(54) SEAL ASSEMBLY FOR HIGH PRESSURE FLUID SYSTEM

(71) Applicant: PSI Pressure Systems LLC, Baytown, TX (US)

(72) Inventor: Jamie A. Forrest, Commerce Township, MI (US)

(21) Appl. No.: 16/448,483

(22) Filed: Jun. 21, 2019

Related U.S. Application Data
(60) Provisional application No. 62/688,526, filed on Jun. 22, 2018.

(51) Int. Cl. F16J 15/3268; F16J 15/3252; F16J 15/40

(52) U.S. Cl. CPC F16J 15/3268; F16J 15/40; F16J 15/3252

(57) ABSTRACT

A seal assembly for a positive displacement high pressure liquid pump sealing arrangement is provided including a sealing ring having an outer exterior surface circumferentiated by an annular support ring, the seal assembly configured for placement between static, non-moving surfaces that are mated against one another, within a groove defined by at least one of the mated surfaces.

### BACKGROUND OF THE INVENTION

The present invention relates to a sealing assembly for a high pressure fluid system and more particularly to a sealing assembly that impairs and/or prevents leakage between surfaces of a high pressure fluid pump where the surfaces are statically mated face to face.

High pressure fluid jetting systems or pumps are used in a variety of fluid jetting operations, such as cleaning, pipe clearing, cutting, removal of debris and coating, to name a few. Most such systems include a fluid end assembly, a drive assembly, a pressurized liquid supply and water blasting equipment, such as a spray gun. The drive assembly usually is in the form of an engine or motor coupled to a drive shaft that drives multiple plungers in a reciprocating manner within a fluid cylinder end. The multiple plungers force fluid, such as water, out of the spray gun at extremely high pressure. As the plungers reciprocate, the fluid cylinder end and its components cycle at an extremely high rate and fluctuate between atmospheric and maximum system pressure, sometimes 40,000 psi or higher.

Within these high pressure systems, there are multiple components that are joined or otherwise fastened to one another with a system of bolts. These components have surfaces that mate against one another, and some of those surfaces define liquid passageways through which the liquid is pumped under high pressure, through one component of the system to the next. Where the components are mated together the surfaces around the passageways must be sealed so that the liquid under high pressure in the passageways does not seep or leak out from the passageways, between the mated surfaces of adjacent parts.

Most high pressure fluid pumps provide such a seal via a system of individual o-rings that are disposed on the mated surfaces, circumferentiating the liquid passageways in an attempt to prevent leaking between the components. To ensure proper mating of the surfaces, the components are compressed against one another with the system of bolts mentioned above. These bolts have to be tightened to a high torque, typically exceeding 400 ft-lbs, and sometimes around 3,000 ft-lbs in certain pumps, to achieve the desired seal between the components. These high torque levels can be difficult to achieve even when an operator is equipped with the proper tools to tighten the bolts. Many times, a diminutive operator will need assistance from another operator or an extension bar on the tool to properly achieve a prescribed torque. This can add to the labor and/or tool costs associated with maintaining a particular high pressure pump.

The use of conventional o-rings as seals in such high pressure pumps has other issues, many of which eventually lead to unwanted leakage. For example, most such o-rings are constructed from a higher durometer urethane. While this is a compressible material, it tends to plastically yield under the types of pressures between mated surfaces in high pressure pumps. Thus, when the pump is repeatedly assembled and reassembled for service of components, many times the o-rings must be replaced because they no longer seal properly. In addition, due to the yielding or other deformations under high pressure, such o-rings will frequently fall out or off of the components to which they are joined when the mating surfaces are removed from one another. Thus, these o-rings can be lost, damaged or destroyed when this occurs, prompting the need for a new replacement o-ring, rather than re-use of the old one.

Typical o-rings used on high pressure pumps can also cause issues during pump disassembly. Such o-rings often times stick to one mating surface when that mating surface is withdrawn from another. Operators may not notice this has occurred as the o-ring is simply missing from their view. As a result, the operator sometimes will install a new o-ring on the other mating surface. This can lead to the old, stuck-on o-ring being installed adjacent the new o-ring so the two stack on one another. With these stacked o-rings, the seal cannot be completed, which will lead to pump failure.

Further, when new, conventional o-rings are installed in high pressure systems, they usually are held in place relative to a mated surface with grease. However, when the components are joined to one under with the high torqued bolt system, if the o-ring is not properly aligned, the grease can facilitate movement of the o-ring, possibly resulting in the o-ring being pinched or crushed between the mated surfaces. In addition, the grease can attract contaminants from the environment around the pump, such as dust, sand, dirt and other debris. These contaminants can reduce the longevity of the o-ring, or affect the way the surfaces mate to one another.

Conventional o-rings in high pressure systems also can be extruded by the liquid under high pressure in the pump. In particular, the pressurized liquid can sometimes seep under pressure, away from the liquid passageway. As it does, it penetrates between the mated surfaces and directly engages the o-ring under the high pressure. The liquid so engaging the o-ring does so under very high pressure. As a result, the liquid can actually extrude the o-ring material so that the material deforms and squishes between the mated surfaces. When so deformed, the o-ring can become misshapen so that it no longer seals properly. In some cases, the o-ring can rip or tear so that it no longer seals the parts around the liquid passageway, leading to potentially catastrophic leaking of the pump. In such a case, the o-ring must be replaced. Such replacement can take several hours to a full day, which means that the pump is out of commission for extended durations. This can be very costly, particularly where the system is being used to clean a plant or facility that is off-line while the cleaning takes place.

While conventional o-rings are commonly used as seals in high pressure pumps, they can be compromised and/or fail in a variety of ways leading to unwanted leaks in the pumps that require the pumps to be taken out of surface for repair. This down time can consume resources and extra labor to fix the leaks. Accordingly, there remains room for improvement in the field of high pressure pump seals.

### SUMMARY OF THE INVENTION

A seal assembly for a positive displacement high pressure liquid pump sealing arrangement is provided including a sealing ring having an outer exterior surface circumferentiated by an annular support ring, the seal assembly configured for placement between static, non-moving surfaces that are mated against one another, within a groove defined by at least one of the mated surfaces.

In one embodiment, the seal assembly can be of a circular configuration and designed for arrangement around a liquid passageway that is formed through adjacent mating surfaces. At least one of the mating surfaces can define an annular groove spaced outward a distance from the liquid passageway. The seal assembly can be disposed at least partially in the annular groove, and placed to prevent seepage or conveyance of liquid under high pressure between the mated surfaces beyond the seal assembly.

In another embodiment, the seal assembly can be configured to circumferentially seal around the first and second liquid passageways such that when pressurized liquid is conveyed between the first and second mating surfaces, the annular support ring prevents the elastomeric sealing ring from being extruded between the first and second mating surfaces, or otherwise from being detrimentally deformed by the high pressure liquid engaging the seal assembly.

In still another embodiment, at least one mated surface defines the annular groove. The annular groove can be sized slightly smaller than a cross section seal assembly. The seal assembly can be placed in the annular groove. Due to the sizing of the seal assembly and its components, the seal assembly snap fits into the groove, staying solidly in place in the groove as another mated surface is engaged against the surface having the assembly in the groove. The two mated surfaces can be forcibly engaged against one another with a system of bolts under designated torque loads, while the seal assembly is self-supported in the groove, optionally without the application of grease or any other materials to secure the seal assembly in place during assembly.

In yet another embodiment, the seal assembly can include a sealing ring. The sealing ring can include a solid cross section with a center of the cross section. The sealing ring can include an inner diameter and an outer diameter separated by the cross section of the sealing ring. The sealing ring can be bisected into front and rear portions via a bisecting plane that passes through the center of the cross section.

In even another embodiment, the sealing ring can include an exterior surface. The exterior surface can be divided into an inner sealing ring surface that is disposed inward of the sealing ring cross sectional center and an outer sealing ring surface that is disposed outward of the sealing ring cross sectional center.

In a further embodiment, the seal assembly can include an annular support ring that is disposed radially outward from the sealing ring, covering the outer diameter of the sealing ring. The annular support ring can be disposed over the outer sealing ring surface, without extending over the inner sealing ring surface. Thus, the inner sealing ring surface can remain exposed to the environment within the annular groove. In some cases, this inner sealing ring surface can engage an inner sidewall of the annular groove, while an outer wall of the support ring, rather than the outer sealing ring surface, engages an outer sidewall of the annular groove.

In still a further embodiment, the seal assembly can include a central longitudinal axis. The parts of the seal assembly, such as the seal ring and the support ring, also can include central longitudinal axes, which can be coincident and/or parallel with the central longitudinal axis of the entire seal assembly.

In yet a further embodiment, the sealing ring can be configured so the part of the exterior surface on the front portion and rear portion, inward from the cross section center, toward the central longitudinal axis of the seal assembly, can be uncovered by and/or not engaged by the support ring. Optionally, this part of the exterior surface can be open to the environment within the annular groove.

In even a further embodiment, the annular support ring can define an inner concave groove that is bounded by a concave groove inner surface. The elastomeric sealing ring can be locked in the concave groove inner surface, with the end portions of the inner surface, near the front and rear of the support ring, forming first and second transitions. These transitions can directly engage the front and rear parts of the exterior surface of the sealing ring. By doing so, the groove and transitions can effectively capture and/or entrap the sealing ring inside the support ring. The sealing ring can bias outward against the concave groove inner surface so that the sealing ring is further secured in that concave groove.

In another, further embodiment, the annular support ring can include a support ring inner diameter and a support ring outer diameter, and an outer wall disposed opposite the inner concave groove. The concave groove inner surface can directly engage the outer sealing ring surface of the exterior surface of the sealing ring, without engaging the inner sealing ring surface.

In still another, further embodiment, the components with the mating surfaces can be parts of high pressure fluid end used in water blasting applications. As an example, one component can be a discharge manifold of a high pressure fluid end, and the other component can be a valve seat assembly having a discharge valve. As another example, one component can be a seal cartridge, and the other can be a valve seat assembly having a discharge valve. As yet another example, one component can be a first high pressure inline pump part and the other can be a second pump part.

In yet another, further embodiment, the components can be secured to one another with one or more fasteners, which are optionally threaded and tightened for such securement. Due to the exceptional sealing capability of the sealing assembly, the fastener can be installed and tightened to a relatively low torque, optionally less than 250 ft-lbs, further optionally less than 225 ft-lbs, yet further optionally less than 200 ft-lbs.

In yet a further embodiment, the seal assembly can include indicia such as color to indicate a particular pressure rating of the seal assembly. For example, seal assemblies rated for systems operating at 40,000 psi can include a first colored support ring, seal assemblies rated for systems operating at 20,000 psi can include a second, different colored support ring, and seal assemblies rated for systems operating at 10,000 psi can include a third, different colored support ring. A variety of colors and indicia can be selected for different pressure ratings.

In still another embodiment, a stand alone seal assembly is provided. The seal assembly can include an elastomeric sealing ring having a central longitudinal axis, an exterior surface, a sealing ring inner diameter, a sealing ring outer diameter and a solid sealing ring cross section having a sealing ring cross sectional center that is radially equal distance from the central longitudinal axis around the sealing ring, the sealing ring being divided into front and rear portions by a sealing ring bisecting plane that passes through the cross sectional center, the exterior surface of the sealing ring being divided into an inner sealing ring surface that is disposed inward of the sealing ring cross sectional center and an outer sealing ring surface that is disposed outward of the sealing ring cross sectional center; and an annular support ring defining an inner concave groove that is bounded by a concave groove inner surface, the annular support ring including a support ring inner diameter and a support ring outer diameter, and an outer wall disposed opposite the inner concave groove.

In even yet another embodiment, a method of operating a high pressure fluid system sealing arrangement is provided. The method can include one or more of the following steps: pumping a pressurized liquid through a liquid passageway at a pressure of at least 10,000 psi, the liquid passageway extending through a first mating surface and a second mating surface that are directly engaged with and static relative to one another, at least one of the first and second mating surfaces defining an annular groove that surrounds the liquid passageway; providing a liquid seal around the liquid passageway via a seal assembly disposed in the annular groove and engaging at least one of the first and second mating surface, the seal assembly comprising an elastomeric sealing ring being entrapped in the inner concave groove of an annular support ring so that the concave groove inner surface directly engages the outer ring surface of the exterior surface of the sealing ring without engaging the inner ring surface; and conveying pressurized liquid outward away from the central longitudinal axis, between the first and second mating surfaces so that the pressurized liquid engages the sealing ring, wherein the annular support ring prevents the sealing ring from being extruded between the first and second mating surfaces.

The current embodiments provides a seal assembly suitable for high pressure fluid system sealing arrangements that can prevent leaking between static, mated surfaces around a liquid passageway that conveys liquid at high pressure. With the seal assembly, external leaking from the system or pump, as well as seal extrusion, can be impaired if not prevented. The seal assembly can withstand extreme operating conditions, for example, in positive displacement triplex or quintuplex ultra-high pressure water pumps operating at approximately 40,000 psi, which pumps, by their very construction, have inherent pulsations due to the sinusoidal movement of a reciprocating plunger. The seal assembly can tolerate possible frequent disassembly of a pump or fluid end for repair, conversion or service. The seal assembly can survive relatively low torque assembly compared to other simple o-ring seal designs. The seal assembly can be used in lower pressure applications, providing superior sealing capabilities. Where the seal assemblies are color coded, this can provide an operator the ability to visually identify and confirm the operating pressure range of a seal assembly and properly install the same. Further, where the seal assembly can be configured to retain itself in a mating part, while the pump is being reassembled and access to the seal is not possible, that seal assembly stays with a base component as it is moved away from the mating face. This can prevent loss or damage to the seal assembly. The seal assembly can be reversible, which can prevent the seal assembly from being positioned or improperly installed, which can lead to a leak in the system.

These and other objects, advantages, and features of the invention will be more fully understood and appreciated by reference to the description of the current embodiment and the drawings.

Before the embodiments are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a front perspective view of a fluid end system or pump including a sealing arrangement having multiple installed seal assemblies of the current embodiment;

FIG. 2 is a section view of a discharge manifold, valve seat assembly, and seal cartridge assembly sealed with respective seal assemblies, taken along line 2-2 of FIG. 1;

FIG. 3 is close up view of an exemplary liquid passageway sealed by the seal assembly taken from III-III in FIG. 1;

FIG. 4 is a front view of an annular support ring of a seal assembly;

FIG. 5 is a section view of the annular support ring taken along line 5-5 of FIG. 4;

FIG. 6 is a perspective sectional view of the annular support ring;

FIG. 7 is a close up section view of an alternative seal assembly with a support ring and seal ring;

FIG. 8 is a close up section view of another alternative embodiment of the seal assembly installed in a groove; and

FIG. 9 is a close up section view of a yet another alternative embodiment of the seal assembly installed in a groove.

### DETAILED DESCRIPTION OF THE CURRENT EMBODIMENTS

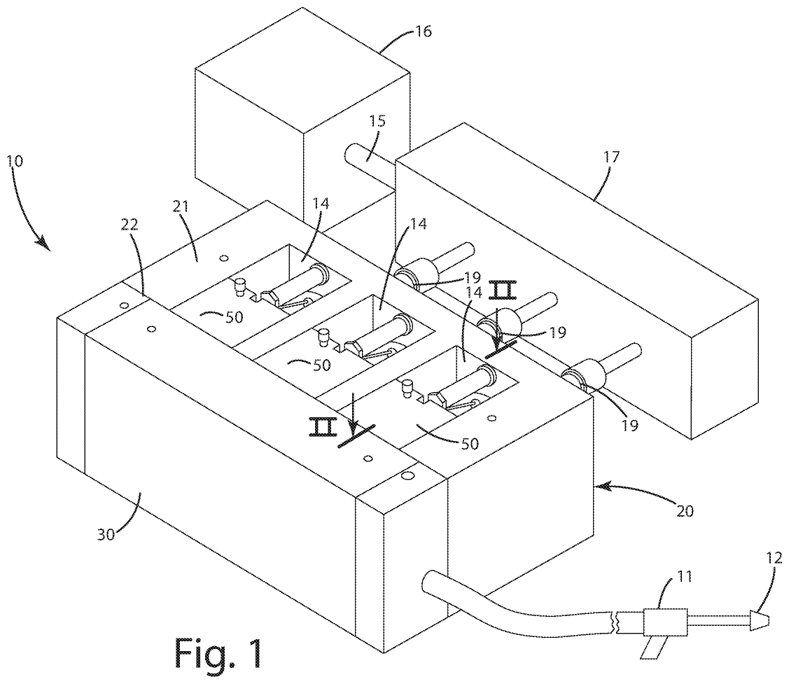

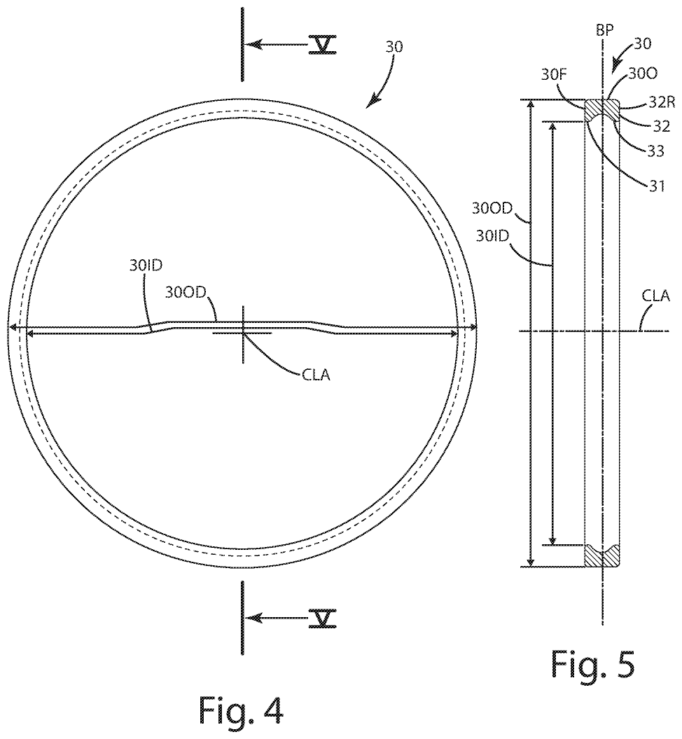

A current embodiment of a seal assembly of the current embodiment, incorporated into a high pressure fluid system arrangement 10, is shown in FIGS. 1-6 and generally designated 20. The high pressure fluid system arrangement 10 can optionally be a fluid end system. While the seal assembly 10 is illustrated and described herein in connection with a particular type of fluid end, disclosed in U.S. Pat. No. 9,371,919 to Forrest et al, which is hereby incorporated by reference in its entirety, the seal assembly can be used in connection with any type of positive displacement high pressure liquid pump, for example, positive displacement triplex pumps, quintuplex pumps, centrifugal pumps, twin screw pumps, progressive cavity pumps, and any other high pressure pump through which liquid is conveyed at high pressure, where the mechanism includes at least two mating surfaces adjacent one another and that remain static relative to one another and a seal is useful relative to the two mating surfaces. The seal assembly described herein is suitable for sealing between static parts or components, optionally where there are no moving components in the region that the seal assembly is located and there theoretically is zero extrusion gap between the components. The seal assembly as described herein, optionally is not used in a dynamic sealing application, where a seal is utilized between two moving components, such as a plunger and a cylinder or sleeve surrounding the plunger. The types of seals used in such a dynamic sealing application can be rather different from the current embodiments of the seal assembly due to the forces and pressures being exerted on the seal at directions 90° off from those typically executed in a static sealing application.

Returning to the present exemplary application where the seal assembly 20 is included in a high pressure fluid end system, that pump will be described briefly here. The fluid end system can include multiple assemblies and components, other than the seal assembly 20. For example, the fluid end 10 can include a frame 12 joined with a discharge manifold 13. The frame can include loading openings 14 sized and shaped to accommodate respective modules 50. These modules 50 optionally can be selectively and easily removable and replaceable relative to the frame and openings to facilitate replacement of worn internal components, for example a valve seat assembly 60 and the seal cartridge assembly 70, also referred to as a stuffing box, and their respective components. The components of the seal cartridge assembly 70 can optionally include a plunger 71 that reciprocally moves to pump fluid in a body 73 under high pressure toward the discharge valve 67 of the valve seat assembly 60. The components of the valve seat assembly 60 can optionally include the discharge valve 67, a discharge valve spring 68S, a manifold seat 68 and a plenum 62. The aforementioned components and other components of the fluid end 20 can be high wear components that are replaced or serviced on a routine basis. Such components also can have one or more pairs of mated surfaces that are sealed to prevent leakage from the fluid end, which is where the seal assemblies 20 are useful. For example, the seal assembly 20 can be disposed between mating surfaces (described below) around a first high pressure liquid passageway 51P, and generally between the manifold 13 and the valve seat assembly 60. Another seal assembly 20′ can be disposed between the same mating surfaces but around another high pressure liquid passageway (not shown), and generally between the manifold 13 and the valve seat assembly 60. Another seal assembly 20″ can be disposed between the valve seat assembly 60 and the plenum 62. Yet another seal assembly 20′″ optionally can be disposed between the seal cartridge assembly 70 and the valve seat assembly 60, for example, its plenum 62. Of course, in different applications and pump configurations, the seal assemblies can be mixed and matched between different surfaces and around different types of high pressure fluid passageways.

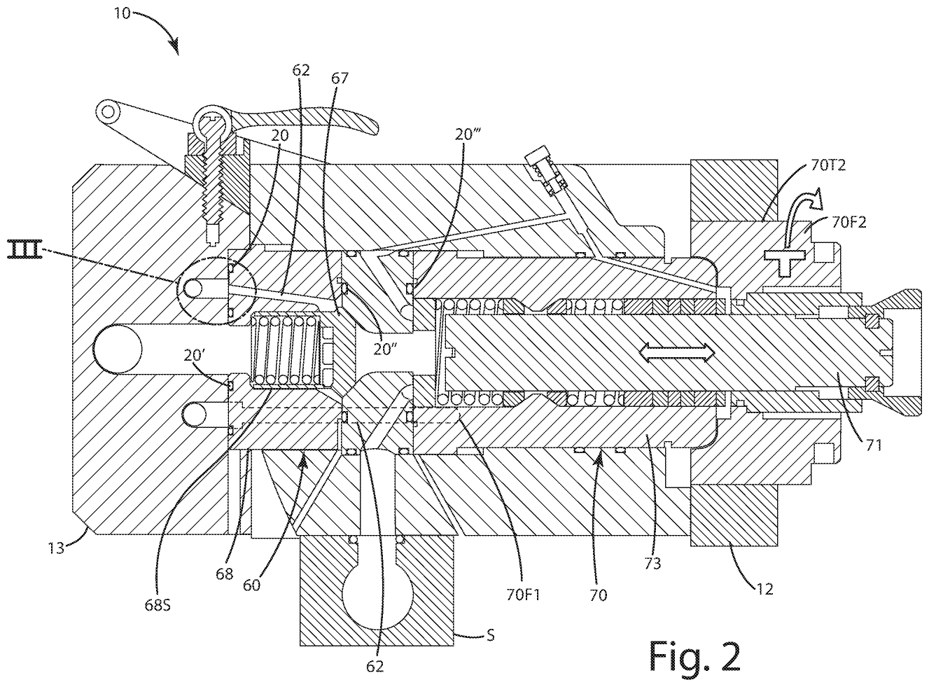

As illustrated in FIGS. 1 and 2, the various components of the pump can be forcibly joined with one another at respective mating surfaces. For example, the valve seat assembly 60 can be forcibly joined with the seal cartridge assembly 70 via one or more fasteners 70F1, which optionally are threaded. Although only one fastener 70F1 is illustrated, there can be multiple such fasteners disposed around the components to bring the respective mating surfaces together in a static, nonmoving configuration to establish a gapless connection. As another example, the valve seat assembly 60 can be forcibly pushed against the manifold 13 via one or more fasteners 70F2 that are tightened or torqued in direction T. This in turn causes the threads 70T of the fastener 70F2 to interface with those of the frame 12, thereby pushing the mating surfaces of the discharge manifold 13 and the valve seat assembly 60 statically against one another in a static, nonmoving configuration to establish a gapless connection, which will be described in further detail below.

FIGS. 1 and 2 also show the fluid end 10 in an exemplary set up. There, the manifold 13 can be connected to a source of water to enable fluid, such as water or other liquid, to enter the discharge manifold 13, become pressurized in the fluid end 10, and ultimately to discharge through the blasting equipment. As illustrated, the blasting equipment can be in the form of an elongated high pressure hose or tube that is further joined with a spray gun 11 or other spray apparatus, which is grasped and manipulated by an operator when performing a cleaning operation using the pressurized fluid, such as water, generated by the fluid end 10. The spray gun 11 can include a nozzle 12 that restricts flow of displaced fluid generated by the fluid end 10. Although it is described herein in connection with a fluid, the fluid end system in most cases can be utilized with a liquid, such as water. The water can be mixed with or substituted with other liquids and/or chemicals for pressurized application via the fluid end system 10 and blasting equipment.

The spray gun 11 can be manipulated by an operator to spray the highly pressurized fluid generated by the fluid end 10. The fluid end 10 can be coupled to a drive unit 16, which is in the form of a diesel or electric powered motor, which drives a driveshaft 15 of a transmission 17. The driveshaft or other components generally engage cross-head stubs 19 to reciprocally drive the plungers 71 and generate pressurized fluid flow through liquid passageways inside the pump, out the manifold and eventually into the water blasting equipment 11. The drive unit, transmission and cross-head stubs can be conventional and will not be described in detail here.

The fluid end system 10 described herein is contemplated to be operated at multiple different pressures. To do so, the system can be outfitted with different pressure rated modules 50. The modules 50 can be outfitted with seal cartridge assemblies, valve seat assemblies and manifold seats and their respective components to generate liquids within then at different pressure ranges. In one embodiment, the pressure ranges of certain modules can be rated at 10,000 psi, other modules can be rated for 20,000 psi and yet other modules can be rated for 40,000 psi. Of course, other high operating pressures can be selected as desired.

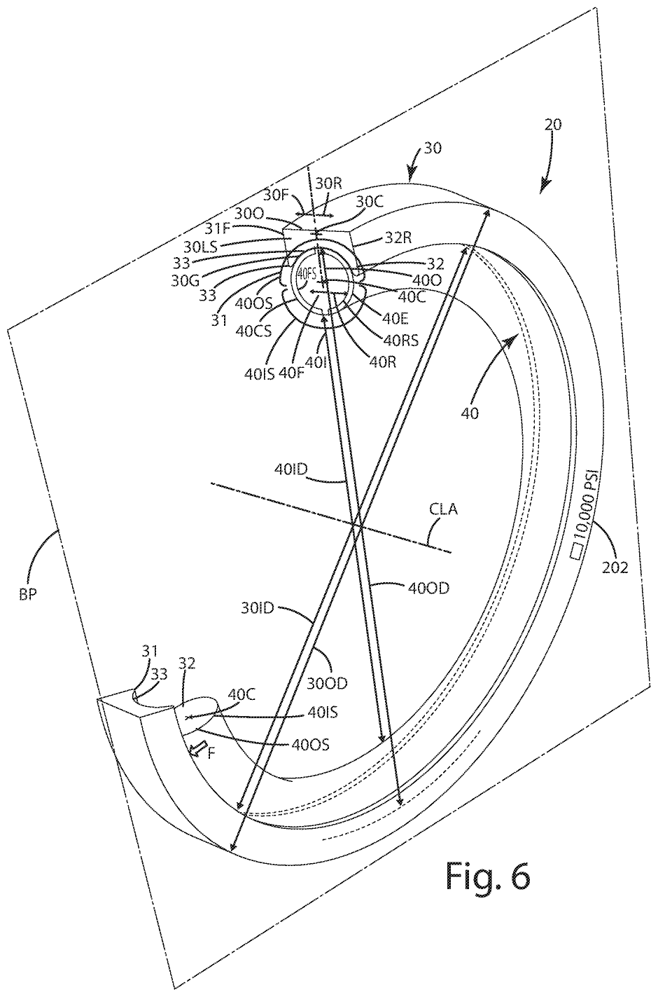

Optionally, the seal assembly 20 can be constructed differently to handle the different pressure ranges of the modules of the fluid end 10 described herein, or to handle different pressure ranges of other high pressure pumps with which the seal assembly can be utilized. For example, the seal assembly can include an indicia and/or a particular color to indicate a pressure range of liquid in a particular passageway that the seal assembly seals so that the seal assembly will only be utilized in connection with a designated appropriate liquid pressure range. This reduces possible operator error possible in mismatching a particular seal assembly with a manifold, seal cartridge assembly and/or a valve seat assembly of a module rated for different pressure ranges. Optionally, as shown in FIG. 6, a seal assembly 20 can be outfitted with an indicia 20Z, which can be an alphanumeric indicator, a particular color within a particular wavelength or some other designation to indicate the operating pressure range with which the seal assembly is useful. As an example, one indicia 20Z on one seal assembly can be red (reflecting a wavelength of 620 nm-750 nm), another indicia on another seal assembly can be green (reflecting a wavelength of 495 nm-570 nm), and yet another indicia on yet another seal assembly can be blue (reflecting a wavelength of 490 nm-550 nm) to designate the different pressure ranges for which the respective seal assemblies are compatible. Again, this can ensure that an operator installing seal assemblies relative to a pump can match the correct seal assembly with the correct components installed in the pump and the operating pressures of the pump. In some applications, a kit of multiple seal assemblies can be provided. The kit can be compatible for use on pumps that require sealing via the seal assemblies at different pressures. As an example, the kit can include a first seal assembly that is of a blue color, representative of safe use in pump applications having an operating pressure range of 5000 psi to 15,000 psi, a second seal assembly that is of a green color, representative of safe use in pump applications having an operating pressure range of 15,000 psi to 25,000 psi, and a third seal assembly that is of a red color, representative of safe use in pump applications having an operating range of 25,000 psi to 50,000 psi. Of course, other colors can be utilized, and more or fewer seal assemblies can be included in a kit for a variety of different pressure range applications.

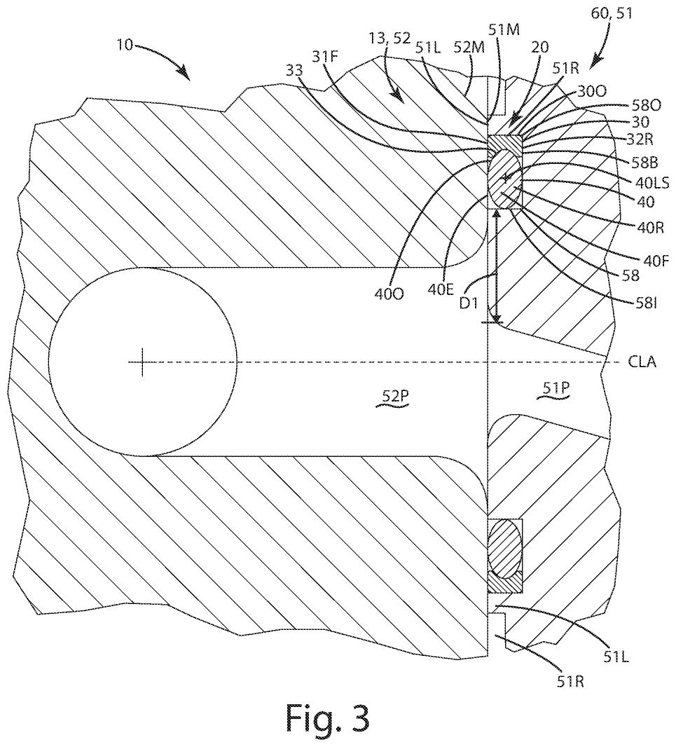

With reference to FIGS. 3-6, the seal assembly 20 and its application in an optional arrangement will now be described in further detail. As shown in FIG. 3, the seal assembly 20 can be disposed between a first component 51 and a second component 52, with the seal assembly 20 surrounding and/or circumferentially sealing a liquid passageway 51P, 52P. The first component 51 can optionally be a valve seat assembly 60 and the second component 52 optionally can be a manifold 13. As mentioned above, the components between which the seal assembly 20 are utilized can be any component of a high pressure pump having static mating surfaces that are forcibly engaged against one another with a passageway being surrounded by the seal assembly.

The first component 51 can define a first liquid passageway 51P, while the second component 52 can define a second liquid passageway 52P. These two liquid passageways can be in fluid communication with one another so as to form a continuous liquid passageway. This continuous liquid passageway again can be circumferentially surrounded by the seal assembly 20 at some preselected distance D1 from the passageway, or in particular, the first or second passageway. This distance D1 can be satisfactory so that a first mating surface 51M of the first component 51 directly and forcibly engages a second mating surface 52M of the second component 52 so that theoretically, liquid in the passageway does not touch or engage the seal assembly 20 due to the mating surface sealing around the passageway, before the liquid is pressurized to a certain pressure range. However, when pressurized, the liquid in the passageway can sometimes seep between the mating surfaces 51M and 52M, which is where the seal assembly 20 functions to form a better seal between the first and second components as described below.

As illustrated in FIG. 3, the first liquid passageway 51P extends through the first mating surface 51M of the first component 51. The second liquid passageway 52P extends through the second mating surface 52M of the second component 52. Again, these first and second passageways can be inset and disposed a preselected distance D1 from the annular groove 58. The distance by which each of the respective passageways can be inset can vary, depending on the relative dimensions of the passageways. For example, the preselected distance D1 can be greater for the component with the first liquid passageway 51P that is of a smaller diameter than the second passageway 52P in the second component. As will be appreciated, the first and second passageways also can be of different dimensions, for example different diameters. In some cases, the diameters optionally can be equal, but in other cases, they are unequal depending on the application and the pressure rating range. The first and second liquid passageways can be configured to convey liquid at a pressure of optionally greater than 5000 psi, further optionally greater than 10,000 psi, yet further optionally greater than 20,000 psi, still further optionally greater than 40,000 psi, yet even further optionally greater than 60,000 psi, even further optionally between 10,000 psi and 40,000 psi, depending on the application.

As mentioned above, the first component 51 can include a first mating surface 51M and the second component 52 can include a second mating surface 52M. The surfaces can be substantially planar where they engage against one another. These mating surfaces can be precision machined to promote zero or no gap in the pump is operating at high pressures in the liquid in the passageway is at those high pressures. These mating surfaces can be finished with a specification to ensure clean and complete contact between the opposing mating surfaces that are brought together under force.

Optionally, one or more of the first and second mating surfaces 51M and 52M can include a metal to metal seal, flange or landing. For example, the first mating surface 51M can include a flange or landing 51L that substantially circumferentiates the seal assembly 20 and the annular groove 58 within which the seal assembly 20 is disposed. This annular flange 51L can completely surround the annular groove and seal assembly. This annular flange can be adjacent a surrounding recess portion 51R of the mating surface 51M. With this type of construction, when the first component 51M and second component 52M are forcibly pushed against one another, the force can be distributed from the first component through the landing or flange 51L and focused on the second mating surface 52M. This can provide localized and increased pressure with which the first mating surface 51M and second mating surface 52M are abutted against and engaged with one another.

As mentioned above, the first component or second component can include an annular groove 58. This annular groove can include an outer diameter sidewall 580, which transitions to the bottom 58B of the annular groove. The groove also can include an inner diameter sidewall 581 which also transitions opposite the outer diameter wall to the bottom 58. The outer diameter wall 580 can form a wall of the flange or landing 51L and transitions generally to the first mating surface 51M at a corner of the groove on the outside diameter of the groove.

Optionally, the seal assembly 20 and, in particular, the support ring 30 disposed outwardly radially from the seal ring 40, can be configured to engage the outer diameter sidewall 580, and a small portion of the bottom wall 58B, and optionally the opposing mating surface 52M the seal assemblies installed. For example, an outer wall 300 of the annular support ring can engage and optionally contact a majority of the outer diameter sidewall, further optionally greater than 50% of the outer diameter sidewall, yet further optionally greater than 75% of the outer diameter sidewall, and even further optionally greater than 95% of the outer diameter sidewall 580.

As illustrated in FIG. 3, the annular groove 58 can be of a generally rectangular configuration, where the outer diameter sidewall 580 and the inner diameter sidewall 581 project from the bottom 58B outward toward the mating surface 51M. The sidewalls can be substantially parallel and optionally perpendicular or at 90° angles relative to the bottom. The dimensions of the groove and the angles of the sidewalls relative to the bottom and one another can be selected to accommodate the seal assembly. With the modification of the angles and the dimensions of the groove, tolerances of the groove relative to the seal assembly can be significantly tighter. In turn, these tighter tolerances and slightly smaller dimensions can ensure that the seal ring and the support ring of the seal assembly are properly compressed inside the annular groove. Indeed, when the seal assembly 20 is installed in the groove, the seal assembly can undergo a compression of at least about 1 pound to about 10 pounds radially toward a central longitudinal axis CLA as described below. This can ensure proper fit and retention of the seal assembly 20 in the groove. Optionally when the components are not joined with one another, in turn, this can prevent the seal assembly from inadvertently dislodging from the groove and becoming lost.

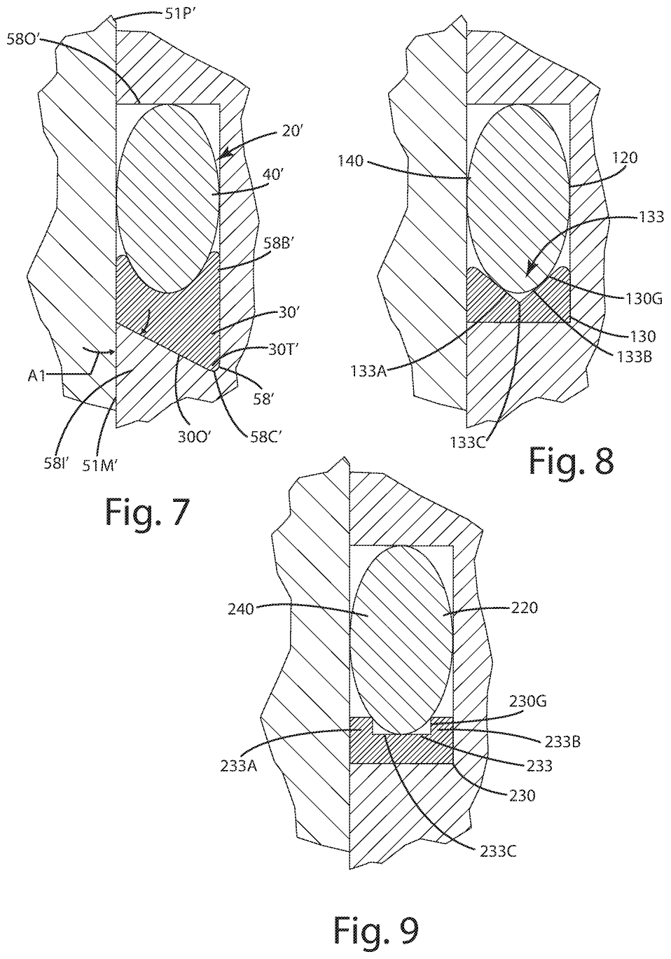

In some applications, the contour or profile of the annular groove 58 optionally can be modified to establish further securement of the seal assembly within the groove. For example with reference to FIG. 7, the groove 58′ optionally can be modified to include a tapered outer diameter sidewall 580′. This tapered outer diameter sidewall 580′ can be angled at an angle A1 relative to the first mating surface 51M′. This angle A1 can be an acute angle, for example optionally less than 90°, further optionally less than 80°, yet further optionally less than 70°, further optionally less than 60°, yet further optionally between 60° and 80° or other angles depending on the application. The support ring 30′ likewise can include a tapered outer wall 300′, which can include an angle A1 similar to the angled outer diameter sidewall 580′. This tapered outer wall 300′ can wedge into and against the outer diameter sidewall 580′, and can partially engage the wall 581′. An inner tip 30T′ of the support ring 30′ can nest within and can be wedged within the outside corner 58C′ where the outer diameter sidewall 581′ and bottom 58B′ of the groove sidewall 580′ intersect. This can provide further securement of the seal assembly 20′ within the groove 58′ when installed. Thus, the tapered outer wall 300′ engages and is trapped partially by the outer diameter sidewalls 581′.

Returning to the current embodiment in FIGS. 3-6, the seal assembly will now be described in further detail. To begin, the seal assembly 20 as mentioned above includes a seal ring 40 and a support ring 30. Both of these rings can be in the form of a circular element. The seal assembly 20 can have a central longitudinal axis CLA. The central longitudinal axis can correspond to, and can be coincident with and/or parallel to a central longitudinal axis of the seal assembly 20 in general and the support ring 30. Thus, when referring to the central longitudinal axis CLA, this generally can refer to an axis of any of these elements and/or the seal assembly.

The sealing ring 40 optionally can be in the form of a torus centered on the central longitudinal axis CLA of the sealing ring. The sealing ring 20 can be circular, and can include the above-mentioned central longitudinal axis. The various elements and parts of the sealing ring can be disposed at particular radial distances from the central longitudinal axis CLA as described below. As shown in FIG. 6, the sealing ring can include a solid sealing ring cross section 40CS that is surrounded by an exterior surface 40E of the sealing ring 40. The exterior surface can form the outside and boundary of the cross section 40CS. The sealing ring can include a sealing ring inner diameter 401D and a sealing ring outer diameter 400D which generally passes through the central longitudinal CLA, as well as the sealing ring cross sectional center 40C. The sealing ring cross sectional center 40C can be radially equal distance from the central longitudinal axis CLA around the entire sealing ring 40.

The sealing ring can be associated with a bisecting plane BP that passes through the cross sectional center 40C of the sealing ring 40. This bisecting plane BP can divide the sealing ring into front 40F and rear 40R portions of the sealing ring. The front portion 40F generally faces toward and engages the second mating surface 52M of the second component. The rear portion 40R can generally face toward and engage a bottom 58B of the annular groove 58. The seal assembly can be reversible so that these front and rear portions can be reversed. This can ensure that the seal assembly is properly placed and facing the correct direction to impair and/or prevent leaking or seal failure.

The sealing ring 40 also can do be divided into an inner portion 401 and an outer portion 400. These portions are divided by a line extending through the center 40C of the cross-section 40CS. The exterior surface 40E of the sealing ring also can likewise be divided into corresponding inner sealing ring surface 401S and a corresponding outer sealing ring surface 40OS. The inner ring surface is disposed inward of the sealing ring cross-sectional center 40C, and the outer sealing ring surface is disposed outward of the sealing ring cross-sectional center 40C. Relative to the central longitudinal axis CLA, an element is outward of the sealing ring cross-sectional center if it is radially farther away from the central longitudinal axis CLA than the center 40C, but is inward of the sealing ring cross-sectional center if it is radially closer to the central longitudinal axis CLA than the center 40C. With such a construction, the exterior surface 40E can be divided into an outer surface 40OS and an inner surface 40IS. The outer surface faces outward, away from the central longitudinal axis CLA, while the inner sealing ring surface 40 IAS faces inward, toward the central longitudinal axis CLA.

The seal assembly 20 also includes the above-noted support ring 30. The support ring can be of an annular shape, circumferentiating the sealing ring 40. The support ring 30 can be disposed outwardly relative to the sealing ring, rather than exclusively to the front or to the rear of the sealing ring. The support ring 30 can define an inner concave groove 30G that is bounded by a concave groove inner surface 33. This concave groove inner surface 33 can open inward, toward the central longitudinal axis CLA. The concave groove inner surface as illustrated can be rounded and of an arc or parabolic shape. The shape can be rounded to match the outer sealing ring surface 400 when the sealing ring 40 is in an uncompressed state as shown for example in FIG. 6. When compressed within the annular groove or generally between mating surfaces, however, as shown in FIG. 3, the outer sealing ring surface can change in shape and can be different from the shape of the concave groove inner surface so that some of the concave groove inner surface is not directly engaged with the outer sealing ring surface 400. Indeed, some of the outer sealing ring surface can become disengaged from the outer parts or transitions of the inner surface where the sealing ring is compressed.

As shown in its assembled state, the sealing ring 40 is disposed at least partially in the inner concave groove 30G. In this configuration, the concave groove inner surface 33 directly engages and is in contact with the outer sealing ring surface 40OS of the exterior surface 40E of the sealing ring. In this configuration, whether it is in the uninstalled configuration shown in FIG. 6, or the installed configuration shown in FIG. 3, the outer sealing ring surface 40OS engages the concave groove inner surface 33, but does not engage the inner sealing ring surface 40IS. That concave groove inner surface 33 also can engage the front portion 40F and the rear portion 40R of the sealing ring 40. In some cases, the concave groove inner surface 33 engages the outer sealing ring surface 40OS on both sides of the bisecting plane BP, optionally engaging again both the front surface 40FS and the rear surface 40RS that correspond to the respective front portion 40F and rear portion 40R sealing ring.

Optionally, although the concave groove 30G is illustrated as including a rounded concave surface, that surface can be modified. For example, with reference to FIG. 8, the alternative support ring 130 shown there can be constructed to include a concave groove 130G having a concave groove inner surface 133 that includes first 133A and second 133B, generally planar surfaces that join one another at an apex 133C. In this construction, the two flat surfaces are angled relative to one another and intersect one another. The precise angle can be selected depending on the orientation of the sealing ring 140 used in the application. The angle A5 of the surfaces 133A and 133B relative to one another can be selected so that forces on the sealing ring 140 push the ring toward the apex 133C, rather than extruding the ring between the noted part surfaces. Further, although shown as including two surfaces that are angled relative to one another, the construction can include multiple angled surfaces that mimic a curved or rounded configuration, where each of the surfaces is of a small dimension. As another example of an alternative support ring, with reference to FIG. 9, the support ring 230 can be constructed so that the concave inner concave groove 230G is of polygonal, for example, a rectangular configuration. The inner surface 233 can form a channel with sidewalls 233A and 233B that are joined via an outside wall 233C. This effectively can form a channel within which a portion of the sealing ring can project as illustrated. Of course, other configurations for the concave inner groove can be selected depending on the application.

Returning to the seal assembly 20 shown in FIGS. 3-6, the annular support ring 30 can be divided into a support ring front portion 30F and a support ring rear portion 30R the bisecting plane BP the crosses through a cross-sectional center 30C of a support ring cross-section 30CS of the support ring 30. The concave groove inner surface 33 can include a first transition 31 that is disposed in the support ring front portion 30F. The concave groove inner surface 33 also can include a second transition 32 that is disposed in the support ring rear portion 30R. These first transitions can come to separate linear points or angles. The first transition can be contiguous with a front side wall 31F, while the second transition can be contiguous with the rear side wall 32R of the support ring. Each of the front side wall and rear sidewall can transition to the outer wall 300 of the support ring 30. The outer wall 300 can be substantially planar as illustrated, so that it forms a cylindrical wall around the exterior portion of the outermost portion of the seal assembly 20. Of course, is mentioned above, it can take another shapes and forms depending on its interaction with the annular groove 58 or other components.

The first transition 31 and second transition 32 can be configured to engage the exterior surface 40E of the support ring in particular locations. For example, the first transition 31 engages the front surface 40FS and the front portion 40F of the sealing ring. The second transition 32 engages the rear surface 4ORS and the rear portion 40R. The first transition and second transition engage these surfaces optionally only in the outer surface portion 40OS or the outer portion of the sealing ring, which extends radially outward from the center 40C of the sealing ring cross-section. Substantially all of the concave groove inner surface 33 can be disposed radially outward from the sealing ring cross-sectional center 40C. Substantially all of the concave groove inner surface 33 can be disposed radially outward from any portion of the sealing ring inner exterior surface 401S. Optionally, none of the support ring or the concave groove inner surface engages the inner surface 401S of the sealing ring. Further optionally, the support ring and concave groove inner surface thereof only engage the sealing ring radially outward from the center 40C of the sealing ring, and further optionally only engage the outer surface 40OS of the sealing ring.

When installed in a groove, as shown in FIG. 3, the front side wall 31F can engage the second mating surface 52M. The rear sidewall 32R can engage the bottom 58B of the groove 58. The outer wall 300 can engage the outer side wall 580 of the groove 58. The outer wall 300 optionally does not engage the bottom wall 58B nor the inner wall 581 of the groove 58. The rear wall 32R optionally does not engage the outer wall 580 of the groove 58, similar to the front wall 31F not engaging that outer wall 580.

The support ring 30 can include an inner diameter 31ID and outer diameter 300D. The inner diameter 301D can correspond to the distance between the transitions diametrically across from one another on opposite sides of the central longitudinal axis CLA. The outer diameter can correspond to the distance between the outer wall 300 on opposite sides of the central longitudinal axis CLA. Optionally, the support ring inner diameter 301D can be greater than the sealing ring inner diameter 401D. The support ring outer diameter 300D can be greater than the sealing ring outer diameter and greater than the sealing ring inner diameter. Further optionally, the support ring inner diameter and be greater than the diameter that passes through the cross-sectional center 40C the sealing ring on opposite sides of the central longitudinal axis.

The support ring and sealing ring can interact with one another so that the support ring effectively traps the sealing ring inside the concave inner groove. The sealing ring 40 can be installed in the outwardly displaced support ring by biasing and slightly compressing the sealing ring toward the central longitudinal axis CLA. In some cases, the support ring can be bent inward toward the central longitudinal axis CLA so that it acquires a U-shape. The U-shape can then be placed inside the concave inner groove 30G. The sealing ring 40 can then be released so that the converts from a U-shape to the circular shape as shown. As it does, the sealing ring can press outward so that the sealing ring is urged against the inner annular groove of the support ring. The sealing ring can expand so that it exerts a force of optionally at least 0.25 pounds, further optionally at least 0.5 pounds, yet further optionally between 0.25 and 1 pound of force F outward against the support ring. With the sealing ring being biased outwardly against the support ring, the sealing ring can be effectively forcibly trapped in the groove to provide better securement therein.

As illustrated in FIGS. 2-3, the various components of the pump 10 can be forcibly joined with one another via one or more fasteners 70F1 and 70F2. As mentioned above, the fasteners join various components of the pump to one another so that their mating surfaces are in fixed, nonmoving static positions relative to one another, and the seal assembly 20 is placed between those static nonmoving mating surfaces to prevent leakage from the liquid passageways 51P, 52P. These mated surfaces 51M, 52M can be forcibly pushed against one another via the fasteners. In such a case, the components 51 and 52 can be joined with the one or more fasteners. The fasteners can be threaded and then tightened to a particular torque. Applicant has discovered that the seal assembly 20 can surprisingly and unexpectedly reduce the amount of torque required to tighten the fasteners and thus forcibly push the mating surfaces against one another, yet still provide an adequate seal around a high pressure liquid passageway. For example, in pumps where liquid is conveyed through liquid passageways at pressures expected to exceed 40,000 psi, the components defining the liquid passageways can be outfitted with conventional 90 durometer urethane O-rings to seal around the liquid passageways. The components are compressed against one another so that their mating surfaces are adjacent one another, utilizing fasteners that are tightened to a torque of at least 400 foot-pounds to ensure that the O-ring satisfactory seals around the high-pressure liquid passageway between the mating surfaces. When those same pumps are outfitted with the seal assembly 20 as described herein, to seal around the liquid passageways, the fasteners are only tightened to a torque of less than 250 foot-pounds, optionally less than 200 foot-pounds, yet further optionally less than 175 foot-pounds to ensure that the seal assembly satisfactorily seals around the high-pressure liquid passageway between the mating surfaces. Based on these numbers, when using the seal assembly herein, the amount of torque applied to secure the components to one another can be reduced by optionally ⅓, further optionally by ⅖, yet further optionally by about ½ the amount of torque used instead with conventional O-rings. This is a substantial improvement and can reduce the difficulty in properly torquing fasteners to join components and effectively seal them in a high pressure pump system.

The sealing ring 40 can be constructed from a variety of materials, for example, natural and synthetic rubber, urethane, nitrile buna-n, Viton®, silicone, polyester polymers, such as polycaprolactones, combinations of the foregoing and other materials. generally, the sealing ring is elastomeric, that is, it can constructed from a polymer with elasticity and some level of viscosity with a generally low Young's modulus. Optionally, the material can express certain properties and characteristics. For example, it can compress plastically to form an exceptional fit within the annular groove at the time of assembly, yet retain enough strength and plasticity to retain elastic deformation that allows the seal ring to be compressed and expand during assembly and disassembly of the components multiple times. This can be helpful because many pumps are repeatedly assembled and disassembled for surface or conversion. The support ring 30 also can be can be constructed from a variety of materials, for example, thermoplastic polymers, metal such as alloys and aluminum, composites, and combinations of the foregoing and other materials. The seal ring and support ring can be chemically resistant to aggressive environments and generally unaffected upon the application of harsh chemicals such as petroleum products, acid acids, and other compounds.

Operation of the high-pressure fluid system and sealing arrangement including the seal assembly of the current embodiments will now be briefly described here. In general, a method of operation can include: pumping a pressurized liquid through a liquid passageway at a pressure of at least 10,000 psi, the liquid passageway extending through a first mating surface and a second mating surface that are directly engaged with and static relative to one another, at least one of the first and second mating surfaces defining an annular groove that surrounds the liquid passageway; providing a liquid seal around the liquid passageway via a seal assembly disposed in the annular groove and engaging at least one of the first and second mating surface, the seal assembly comprising an elastomeric sealing ring being entrapped in the inner concave groove of and annular support ring so that the concave groove inner surface directly engages the outer ring surface of the exterior surface of the sealing ring without engaging the inner ring surface; and conveying pressurized liquid outward away from the central longitudinal axis, between the first and second mating surfaces so that the pressurized liquid engages the sealing ring, wherein the annular support ring prevents the sealing ring from being extruded between the first and second mating surfaces.

As mentioned above, the pressurized liquid can be pumped through the liquid passageways at other pressures, for example 20,000 psi or 40,000 psi and above, depending on the application. Due to the effectiveness and efficiency of the sealing assembly, the mating surfaces of the different components in the above method can be urged toward one another with one or more fasteners are tied to a torque of less than 250 foot-pounds which again is less than the amount utilized when the seal assembly is replaced with an O ring.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual elements of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. Any reference to claim elements as “at least one of X, Y and Z” is meant to include any one of X, Y or Z individually, and any combination of X, Y and Z, for example, X, Y, Z; X, Y; X, Z; and Y, Z.

The embodiments of the invention in which an exclusive property or privilege is claimed are defined as follows:

1. A high pressure fluid system sealing arrangement comprising:
a first component including a first mating surface and defining a first liquid passageway that extends through the first mating surface, the first mating surface defining an annular groove that circumferentiates the first liquid passageway, the annular groove being disposed a predetermined distance outward from the first liquid passageway;
a second component including a second mating surface and defining a second liquid passageway that extends through the second mating surface, the second liquid passageway in fluid communication with the first liquid passageway;
a fastener joining the first component with the second component in a fixed, static configuration so that the first mating surface engages the second mating surface and does not move relative thereto;
a seal assembly disposed in the annular groove and extending around the first liquid passageway, the seal assembly sealingly engaged against the second mating surface, the seal assembly comprising:
an elastomeric sealing ring having a central longitudinal axis, an exterior surface, a sealing ring inner diameter, a sealing ring outer diameter and a solid sealing ring cross section having a sealing ring cross sectional center that is radially equidistant from the central longitudinal axis around the sealing ring, the sealing ring being divided into front and rear portions by a sealing ring bisecting plane that passes through the cross sectional center, the exterior surface of the sealing ring being divided into an inner sealing ring surface that is disposed inward of the sealing ring cross sectional center and an outer sealing ring surface that is disposed outward of the sealing ring cross sectional center;
an annular support ring defining an inner concave groove that is bounded by a concave groove inner surface, the annular support ring including a support ring inner diameter and a support ring outer diameter, and an outer wall disposed opposite the inner concave groove,
wherein the elastomeric sealing ring is disposed at least partially in the inner concave groove of the annular support ring so that the concave groove inner surface directly engages the outer sealing ring surface of the exterior surface of the sealing ring but does not engage the inner sealing ring surface,
whereby the seal assembly is configured to circumferentially seal around the first and second liquid passageways such that when pressurized liquid is conveyed between the first and second mating surfaces, the annular support ring prevents the elastomeric sealing ring from being extruded between the first and second mating surfaces.

2. The high pressure fluid system sealing arrangement of claim 1,
wherein the first component is a valve seat assembly having a discharge valve,
wherein the second component is a discharge manifold of a high pressure fluid end.

3. The high pressure fluid system sealing arrangement of claim 1,
wherein the first component is a discharge manifold of a high pressure fluid end,
wherein the second component is a valve seat assembly having a discharge valve.

4. The high pressure fluid system sealing arrangement of claim 1,
wherein the fastener is a threaded fastener tightened to a torque of less than 250 ft-lbs,
wherein the first and second liquid passageways are configured to convey liquid at a pressure of greater than 10,000 psi.

5. The high pressure fluid system sealing arrangement of claim 1,
wherein the inner concave groove of the annular support ring opens inward, toward the central longitudinal axis of the sealing ring.

6. The high pressure fluid system sealing arrangement of claim 1,
wherein the annular support ring is divided into a support ring front portion and a support ring rear portion by a support ring bisecting plane that passes through a cross sectional center of a support ring cross section of the support ring,
wherein the concave groove inner surface includes a first transition that is disposed in the support ring front portion, the first transition contiguous with a front side wall that transitions to the outer wall,
wherein the concave groove inner surface includes a second transition that is disposed in the support ring rear portion, the second transition contiguous with a rear side wall that transitions to the outer wall.

7. The high pressure fluid system sealing arrangement of claim 6,
wherein the front side wall engages the second mating surface,
wherein the rear side wall engages a bottom of the annular groove defined by the first mating surface.

8. The high pressure fluid system sealing arrangement of claim 1,
wherein the support ring inner diameter is greater than the sealing ring inner diameter,
wherein the support ring outer diameter is greater than the sealing ring outer diameter.

9. The high pressure fluid system sealing arrangement of claim 1,
wherein all of the concave groove inner surface is disposed radially outward from the sealing ring cross sectional center.

10. The high pressure fluid system sealing arrangement of claim 1,
wherein the concave groove inner surface is rounded to correspond substantially to a shape of the outer ring surface of the exterior surface of the sealing ring.

11. The high pressure fluid system sealing arrangement of claim 1,
wherein the concave groove inner surface is rounded to correspond substantially to a shape of the outer ring surface of the exterior surface of the sealing ring.

12. The high pressure fluid system sealing arrangement of claim 1,
wherein the concave groove inner surface transitions to a front side wall at a first transition and to a rear side wall at a second transition,
wherein the first transition engages the front portion of the sealing ring,
wherein the second transition engages the rear portion of the sealing ring, distal from the front portion or the sealing ring.

13. A high pressure fluid system sealing arrangement comprising:
a first component including a first mating surface;
a second component including a second mating surface, at least one of the first mating surface and the second mating surface defining an annular groove, the first and second components fixedly and immovably joined in a static configuration so that the first mating surface engages the second mating surface and does not move relative thereto;
a seal assembly disposed in the annular groove and engaged against at least one of the first and second mating surface, the seal assembly comprising:
an elastomeric sealing ring having a central longitudinal axis, an exterior surface, a sealing ring inner diameter, a sealing ring outer diameter and a solid sealing ring cross section having a sealing ring cross sectional center that is radially equidistant from the central longitudinal axis around the entire sealing ring, the exterior surface of the sealing ring being divided into an inner ring surface that is disposed inward of the sealing ring cross sectional center and an outer ring surface that is disposed outward of the sealing ring cross sectional center;
an annular support ring defining an inner concave groove that is bounded by a concave groove inner surface,
wherein the elastomeric sealing ring is disposed at least partially in the inner concave groove of the annular support ring so that the concave groove inner surface directly engages the outer ring surface of the exterior surface of the sealing ring but does not engage the inner ring surface,
whereby the seal assembly is configured to circumferentially seal around a liquid passageway such that when pressurized liquid is conveyed between the first and second mating surfaces, the annular support ring prevents the elastomeric sealing ring from being extruded between the first and second mating surfaces.

14. The high pressure fluid system sealing arrangement of claim 13,
wherein the first component is a valve seat assembly having a discharge valve,
wherein the second component is a discharge manifold of a high pressure fluid end.

15. The high pressure fluid system sealing arrangement of claim 13,
wherein the first and second components are joined with a fastener tightened to a torque of less than 250 ft-lbs.

16. The high pressure fluid system sealing arrangement of claim 13,
wherein the concave groove inner surface includes a transition that is contiguous with a sidewall that transitions to an outer wall,
wherein the support ring includes an inner support ring diameter that is bounded by the first transition,
wherein the inner support ring diameter is greater than the sealing ring inner diameter, and less than the sealing ring outer diameter,
wherein the support ring is entrapped in the concave groove inner surface by the transition.

17. The high pressure fluid system sealing arrangement of claim 13,
wherein the concave groove inner surface includes a first transition that is contiguous with a first sidewall that transitions to an outer wall,
wherein the concave groove inner surface includes a second transition that is contiguous with a second sidewall that transitions to the outer wall,
wherein the sealing ring is divided into front and rear portions by a sealing ring bisecting plane that passes through the cross sectional center,
wherein the first transition engages the front portion of the sealing ring,
wherein the second transition engages the rear portion of the sealing ring distal from the front portion,
wherein the support ring is entrapped in the concave groove inner surface by the first transition and the second transition.

18. A method of operating a high pressure fluid system sealing arrangement, the method comprising:
pumping a pressurized liquid through a liquid passageway at a pressure of at least 10,000 psi, the liquid passageway extending through a first mating surface and a second mating surface that are directly engaged with and static relative to one another, at least one of the first and second mating surfaces defining an annular groove that surrounds the liquid passageway;
providing a liquid seal around the liquid passageway via a seal assembly disposed in the annular groove and engaging at least one of the first and second mating surface, the seal assembly comprising an elastomeric sealing ring having a central longitudinal axis and an exterior surface, the exterior surface of the sealing ring being divided into an inner ring exterior surface that is disposed inward of a sealing ring cross sectional center and an outer ring exterior surface that is disposed outward of the sealing ring cross sectional center, and an annular support ring defining an inner concave groove that is bounded by a concave groove inner surface, the elastomeric sealing ring being entrapped in the inner concave groove of the annular support ring so that the concave groove inner surface directly engages the outer ring surface of the exterior surface of the sealing ring without engaging the inner ring surface; and
conveying pressurized liquid outward away from the central longitudinal axis, between the first and second mating surfaces so that the pressurized liquid engages the sealing ring,
wherein the annular support ring prevents the sealing ring from being extruded between the first and second mating surfaces.

19. The method of claim 18, comprising:
urging the first and second mating surfaces toward one another with at least one fastener tightened to a torque of less than 250 ft-lbs.

20. The method of claim 19,
wherein the entire support ring is disposed farther from the central longitudinal axis of the sealing ring than the sealing ring cross sectional center is disposed from the central longitudinal axis of the sealing ring,
wherein the concave groove inner surface includes a first transition that is contiguous with a first sidewall that transitions to an outer wall,
wherein the concave groove inner surface includes a second transition that is contiguous with a second sidewall that transitions to the outer wall,
wherein the first transition engages a front portion of the sealing ring,
wherein the second transition engages a rear portion of the sealing ring distal from the front portion,
wherein the support ring is entrapped in the concave groove inner surface by the first transition and the second transition during the conveying step.
